(19) United States
(12) Patent Application Publication
(10) Pub. No.: US 2008/0251638 A1
(43) Pub. Date: Oct. 16, 2008

(54) LANDING GEAR LEGS AND METHOD OF MAKING

(76) Inventor: Clifford B. Cordy, Port Orchard, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/770,534

(22) Filed: Jun. 28, 2007

Related U.S. Application Data
(63) Continuation-in-part of application No. 10/924,782, filed on Aug. 25, 2004, now abandoned.

(51) Int. Cl. B64C 25/00

(52) U.S. Cl. 244/100 R

(57) ABSTRACT

An airplane gear leg that is strong, stiff, and capable of storing large amounts of energy and formed of a composite material that has first and second fiber materials. The first fiber material is very strong and flexible, allowing it to store a great deal of energy in a hard landing, and its fibers are oriented essentially parallel to the axis of the gear leg. The second fiber material is very stiff, providing the torsional rigidity necessary to avoid flutter, and its stiff fibers are laid at a large angle relative to the axis of the gear leg so their elastic limit is not exceeded during a hard landing.

### BACKGROUND OF THE INVENTION

1. Field of the Invention

The present disclosure pertains to landing gear legs formed of composite material.

2. Description of the Related Art

Pilots are known to make spectacularly bad landings. The landing gear of the airplane is expected to survive such landings. To do so, the landing gear must be extremely strong and somewhat flexible. The airplane has some predetermined gross weight. There is some rate of descent when contact (impact) is made with an unyielding surface (runway). The maximum kinetic energy associated with a given rate of descent is:

E=mV²/2

where m is the maximum allowed gross mass of the airplane and V is the maximum rate of descent at impact that must be survived. Of course, a consistent set of units must be used. This is the energy the landing gear must be capable of storing and dissipating. In general, dissipation elements are large, heavy, and not aerodynamic. Thus, in most cases, essentially the entire impact energy must be stored as elastic energy in some form of spring.

For the last 50 or 60 years, the landing gear for most small airplanes consisted of a rod made of spring steel that is attached to the fuselage at one end and the wheel at the other end. Steel is very heavy, but it is cheap, it is stiff, and it will store more energy per unit weight than most other materials. Furthermore, if the plane is landed so hard that the elastic limit of the steel is exceeded, the steel will generally bend a long way before it breaks. This absorbs an enormous amount of energy, one time. Thus, the airplane may look strange while it taxies back to the hangar, but it does not become a pile of rubble on the runway.

Modern composite materials are much lighter than steel. Some, notably carbon, are stronger than steel (higher elastic limit), and much stronger per unit weight. But many of them are very stiff (have a high modulus of elasticity). The energy that can be stored per unit volume of material is proportional to the quotient of its elastic limit divided by its modulus of elasticity. Because of their lower density, some materials, such as carbon, will store more energy per unit weight than will steel, but the difference is considerably less than a factor of 10. Furthermore, when their elastic limits are exceeded, most composites will snap, not bend. If these materials are used in landing gear that is strong enough to survive a landing that will cause steel landing gear to limp back to the hangar bent to weird angles, their weight advantage over steel largely vanishes.

There are fibers, notably Kevlar, that have high yield strength and low modulus of elasticity. Landing gear made of fibers with low modulus of elasticity could survive an impact on landing with no structural damage that would leave steel landing gear weighing more than 10 times as much bent to the point of being unusable for anything more than an emergency exit from the runway. The reason this “obvious” solution is not used is that it causes another problem. Fibers that are not stiff survive the impact because they can absorb or store a great deal of energy. However, landing gear must be stiff. If it is not stiff enough, the wheel, and wheel fairing, will flutter at high flight speeds. This will likely destroy the airplane. Flutter absolutely must be avoided.

### BRIEF SUMMARY

The problem of heavy landing gear is solved by making the gear legs of a composite structure containing two or more fiber materials that have different physical properties from one another. One fiber material, or group of fiber materials, uses fibers with high yield strength and low modulus of elasticity, said fibers running essentially parallel to the axis of the gear leg. These are built into a structure that is much stronger than the present steel gear legs used on airplanes of similar weight. In this case, “stronger” means that it will not break or suffer permanent deformation in an impact that would leave the steel landing gear seriously bent, permanently.

The second fiber material, or group of materials, have moderate to high yield strength and high modulus of elasticity. These are incorporated into the composite at angles far from the axis of the gear leg. These provide the torsional rigidity needed to suppress the tendency of the wheel and its fairing to flutter at high airplane speeds.

Since multiple materials can be incorporated into a composite structure, it is possible to construct landing gear legs of multiple materials in such a way that landing impact energy is stored in a strong, flexible fiber while at the same time a strong, stiff fiber provides rigidity that eliminates flutter. Consider the two requirements in more detail.

Landing impact causes a unidirectional force on the landing gear, UP. The resulting flexure of the landing gear is UP. This is resisted most effectively by incorporating a light, strong, flexible fiber as thick bands in the top and bottom of the gear leg, said fibers lying parallel to the axis of the gear leg. Of course, some additional structure must separate these bands so they act as a beam.

Flutter is an oscillation, generally perpendicular to the air flow, that is driven by an interaction between the air stream over the part in question and the dynamic response of that part to the air flow. Generally, the part has some form of lift that changes with angle of attack and a mass that is not balanced around the axis of rotation of the part in question. In most cases, varying angle of attack plays a critical role in flutter. If the angle of the part cannot change, flutter cannot occur. Thus the gear leg must be stiff to prevent the wheel from fluttering. But, rotational stiffness is the primary requirement for avoiding flutter, and rotational stiffness has little effect on impact energy storage in a hard landing.

Rotational stiffness is maximized by using a fiber with a high modulus of elasticity, not necessarily exceptionally strong. This fiber is formed into a tube, ideally with a circular cross section. The fibers are laid into the surface at large angles to the axis of the tube. In flutter, the initial driving force is typically small, and it increases as the magnitude of the oscillation increases, until something is destroyed. If the part in question is sufficiently stiff to prevent flutter, it does not have to be very strong. Thus, modulus of elasticity is the primary consideration for these fibers.

For an effective gear leg, the two groups of fibers must be combined. The impact energy is stored in the flexible fibers running parallel to the axis of the gear leg (impact fibers, henceforth denoted “(I)”). The torsional rigidity is provided by the fibers laid at a large angle to the axis of the gear leg (torsion fibers, henceforth denoted “(T)”). It is necessary to design the combination such that the maximum impact survivable by the impact fibers does not exceed the yield strength of the torsion fibers. If this requirement is not met, a severe impact with the ground could cause internal damage that is not visible, even under close inspection. The result could be flutter in flight, destruction of the airplane, and death of the occupants.

The maximum survivable elastic deformation (stretch or compression per unit length of fiber) of the impact fibers is proportional to their yield strength divided by their modulus of elasticity. If the wall of the gear leg is thin, the deformation of the torsion fibers is equal to the deformation of the impact fibers times the square of the cosine of the angle between the torsion fibers and the axis of the gear leg. The maximum deformation these fibers can survive is proportional to their yield strength divided by their modulus of elasticity, and the constant of proportionality is the same as that for the impact fibers (because the maximum distance from the principal axis is the same for both). Now:

Deformation(I)=K*Yield(I)/Elasticity(I)

and:

Deformation(T)=K*Yield(T)/Elasticity(T)

while at the same time

Deformation(T)=Deformation(I)*cos² φ

In order to prevent damaging the torsion fibers before damaging the impact fibers in a super hard landing,

0<Cos² φ≦Yield(T)/Yield(I)*Elasticity(I)/Elasticity(T)

Thus, for any combination of materials, it is easy to calculate the maximum allowable cosine of the angle between the axis of the gear leg and the direction at which the (T) fibers are laid in the composite. This yields one range of values, Ø, between 0 and 90° of

90>Ø≧cos⁻¹(sqrt(Yield(T)/Yield(I)*Elasticity(I)/Elasticity(T)))

There are a total of four possible values of φ

φ=Ø, φ=−Ø, φ=180−Ø, and φ=−180+Ø

Obviously, the last two are functionally the same as the first two. A fiber at 80° from the gear leg axis is the same as a fiber at −100 degrees, for instance.

In terms of eliminating the possibility of damaging the (T) fibers, they could be laid at 90 degrees to the axis of the gear leg. However, this would not give the desired torsional rigidity. To achieve torsional rigidity, there must be a web of fibers crossing each other, as shown in FIG. 2. To maximize the torsional strength and rigidity, it is desirable to lay the (T) fibers at an angle only slightly further from zero (in the + and − directions) than that given in the formula above.

In general, fibers with low moduli of elasticity are plastics. Some well known examples are Nylon, Polypropylene, and Kevlar. Some, including Kevlar and some newer materials, are extremely strong in addition. In general, fibers with high moduli of elasticity are made of materials that are quite hard in their bulk form, such as glass and metal. One exception to this is Carbon, which is both very stiff and very strong in its fiber form, but soft in the form of soot or charcoal. Clearly, no generic statement can be made about the nature of the chemical properties of suitable fiber combinations. The only properties important to this invention are the physical properties, modulus of elasticity and yield strength, of the fibers. Examples used within this discussion are given to improve the clarity of the presentation. Clearly, this disclosure is not limited to these materials, and the embodiments described herein cover any composite containing a combination of fiber materials where one or more materials with relatively low modulus of elasticity are incorporated into the composite in a direction largely parallel to the axis of the gear leg, and one or more different materials with relatively high modulus of elasticity are incorporated into the composite at a large angle away from the axis of the gear leg.

### BRIEF DESCRIPTION OF THE SEVERAL VIEWS OF THE DRAWINGS

FIGS. 1A-1B are front views of a generic airplane showing the landing gear legs in a tricycle and tail wheel configuration, respectively.

FIG. 2 is a detail of the lamination in the new, strong, lightweight gear leg.

FIG. 3 is an end view of one possible configuration of the new gear leg showing the relative locations of the impact and torsion fibers.

FIG. 4 is an end view of the new gear leg with one possible fairing added to minimize aerodynamic drag on the structure.

FIG. 5 is an end view of one possible gear leg that incorporates an aerodynamic shape into the gear leg itself.

FIG. 6 is an end view of one possible gear leg for a tail wheel.

### DETAILED DESCRIPTION OF THE INVENTION

In general, the main gear takes the brunt of the impact in a bad landing. Consequently, the drawings and description included here are primarily directed toward the main gear. However, pilots also manage to make colossal impacts with nose and tail wheels, and all descriptions herein are obviously usable in those applications too.

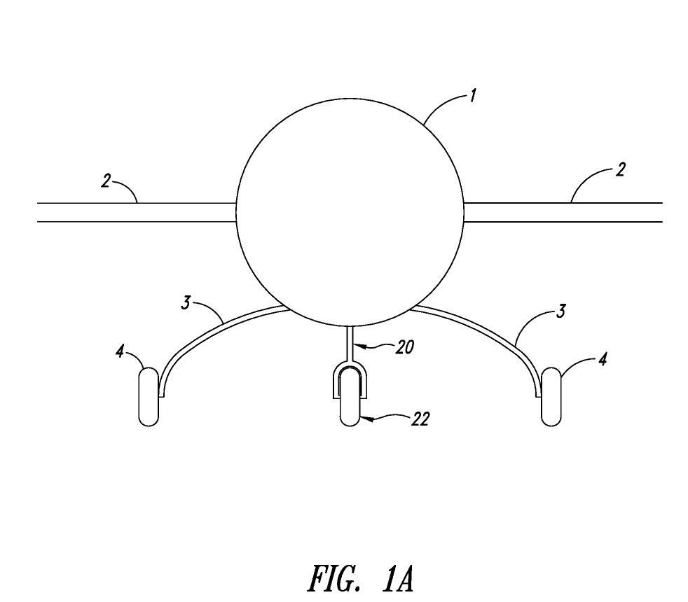

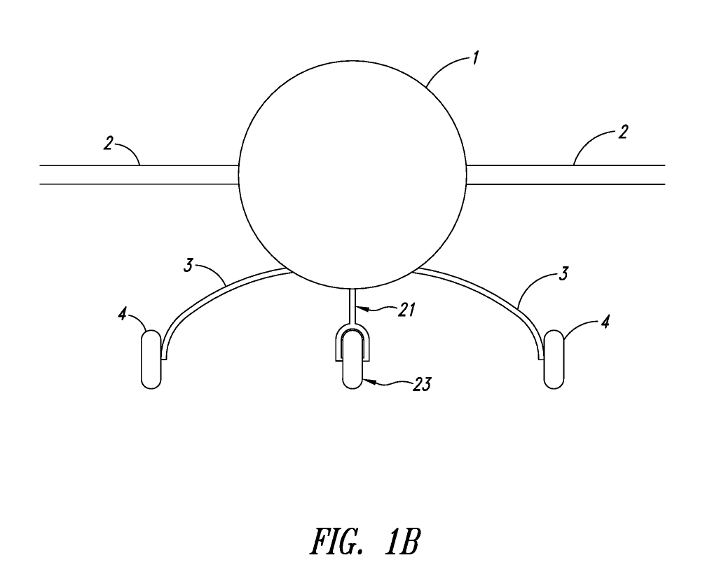

The front view of a generic airplane is shown in FIGS. 1A-1B, with fuselage (1) and wings (2) sitting on gear legs (3). In FIG. 1A, gear legs (3) are rigidly attached to fuselage (1) and to the axles (not shown) of wheel assemblies (4). It is common that gear legs (3) are individual units, each rigidly attached into the structure of fuselage (1). It is also common that gear legs (3) form a single beam between both wheel assemblies (4), with fuselage (1) perched in the middle of said beam. It is also common that gear legs (3) are firmly anchored into the structure of wings (2) rather than fuselage (1). It is also common that gear legs (3) are retractable into fuselage (1) and/or wings (2). Such details of mounting the gear legs to the airplane in no way affect the design described herein. A third gear leg (20) with wheel (22) is shown, which is a nose wheel associated with the fuselage (1). In FIG. 1B the wheel (23) is a tail wheel associated with a leg (21) at the rear of the fuselage (1).

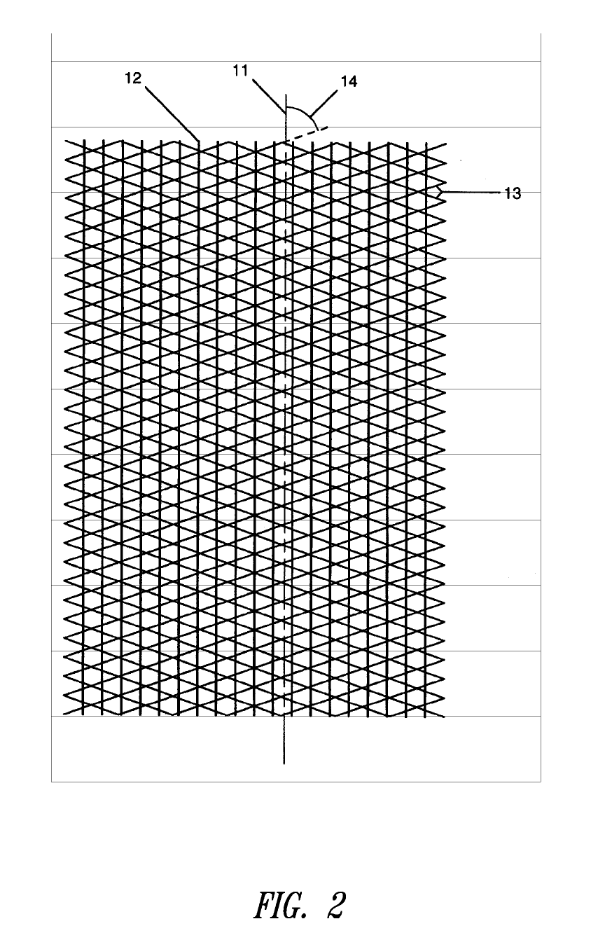

FIG. 2 shows the orientation of the fibers within a small section of the composite lamination. The strong, flexible impact fibers (12) are parallel to the axis (11) of the gear leg. The stiff torsion fibers (13) are at an angle (14) to the axis (11) of the gear leg. Angle (14) is the angle φ in the equations above.

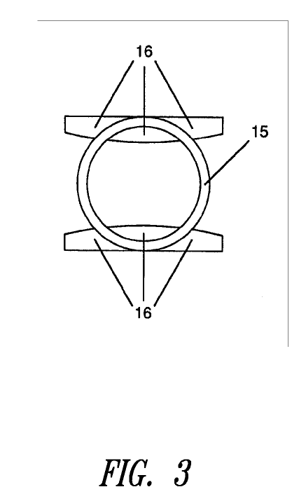

There are many usable configurations for the construction of the gear leg. FIG. 3 shows one of them. In general the torsion fibers will form a torque tube (15), here shown as a circular tube, and the impact fibers will lie in bands toward the top and bottom of the torque tube (15) forming a beam (16). Beam (16) may lie entirely inside torque tube (15), entirely outside of it, or both inside and outside of it, as shown here. Torque tube (15) is not necessarily circular. It may be oval, rectangular, or an irregular shape, in order to conform to other constraints.

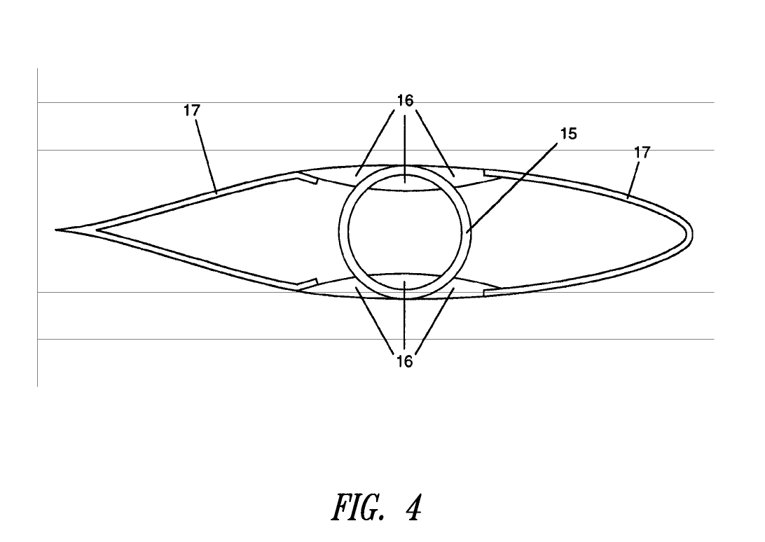

There is no need for the gear leg structure to be an aerodynamic cross section. It is a simple matter to make a fairing that will surround the gear leg. FIG. 4 shows a cross section of the gear leg of FIG. 3, slightly reshaped for aerodynamics, with fairing (17) added. The fairing may be one piece or multiple pieces. It may attach to the gear leg with fasteners, be part of the lamination of the gear leg, or be laminated to the gear leg after the leg is manufactured. Such details of a gear leg fairing, or lack thereof, in no way affect the design described herein.

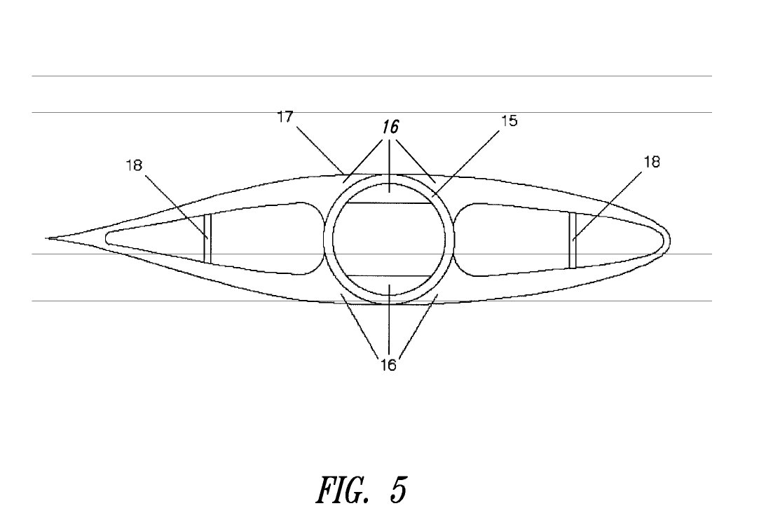

In general, the torque tube will serve to maintain the necessary separation between the impact fibers to make them act as a beam. However, it is entirely possible to add one or more additional webs of material to make the beam stronger. FIG. 5 shows one such possibility. This is the end view of a gear leg formed as an aerodynamic unit, not needing a fairing. Torque tube (15) is formed first. A fairing (17) is formed over torque tube (15) with thick load carrying members (16) incorporated into fairing (17), with two additional webs (18) helping to maintain proper spacing between the main parts of beam (16). For any given impact strength, this configuration produces a smaller structure, with less drag, than the structure of FIG. 4, but it is more difficult to manufacture.

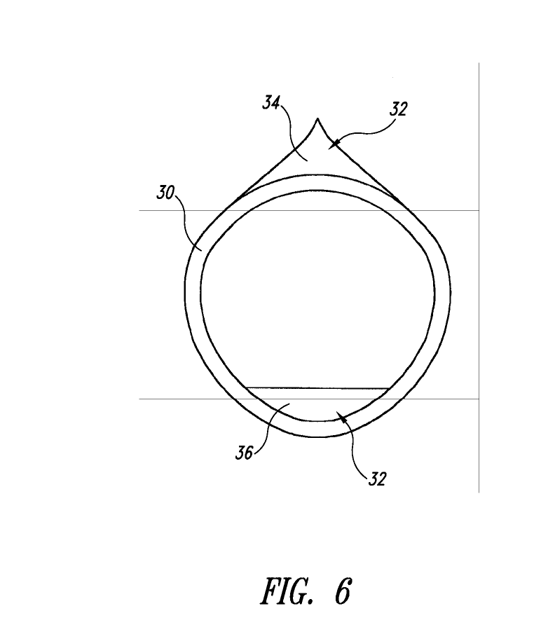

In a gear leg for a tail wheel, the top and bottom of the gear leg are at the ends of the chord of the gear leg, rather than at the thickness of the gear leg. FIG. 6 is the end view of one possible gear leg for holding a tail wheel. Here a nearly circular torque tube (30) occupies a large fraction of the volume of the gear leg. This is shaped to form much of the airfoil of the tail wheel leg. Impact absorbing parts of beam (32) lie above and within torque tube (30) in such a position that the upper part of beam (34) itself completes the aerodynamic shape of the rear of the gear leg and lower part of beam (36) is entirely inside the airfoil shape of torque tube (30). In this end view, the gear leg appears unreasonably fat. However, the gear leg for the tail wheel typically is mounted 700 to 800 from vertical. As seen by the passing air, this shape has a chord to thickness ratio in the range of 5:1.

Manufacture of the gear leg begins with the production of the torque tube. Fabrication of the torque tube involves a more complicated series of steps than that required for a straight tube, such as a vaulting pole. A vaulting pole is wound by spinning a straight mandrill (often made of rubber), in front of a roll of carbon fiber impregnated with epoxy. A carbon fiber strand is pulled off the roll of fiber and wound on the mandrill. The mandrill is moved lengthwise at a speed geared to the rotation speed to get the desired angle between the wound fiber and the axis of the pole. It would be very difficult to do this with the torque tube, which is far from being a straight shaft.

The following steps are one approach for fabricating the torque tube: The first step is the construction of a mandrill of the proper shape. The torque tube fiber (impregnated with epoxy) is wound on the mandrill. Techniques similar to winding wire on a toroidal magnetic core can be used. Then the torque tube is cured at elevated temperature and the mandrill is removed. Because a vaulting pole is continuously tapered, a fairly hard rubber mandrill is easy to pull out of the big end. The torque tube of the present embodiment is likely to be a smaller diameter at both ends than it is in the middle, making it more difficult (if not impossible) to remove a rubber mandrill. Preferably, the mandrill will be formed of a substance such as a hard wax or a metal with a low melting temperature, that will not melt at the desired cure temperature. After the torque tube is cured, the temperature is raised a bit more to melt the mandrill, and the mandrill material simply runs out one or both ends.

Another approach for fabrication of the torque tube is to make a pair of female molds for forming a mandrill for the torque tube. The mandrill only needs to be strong enough to support the weight of the torque tube during its fabrication, so the walls of the mandrill can be very thin. The mandrill material is placed in the molds, the two mold halves are clamped together, and the mandrill is cured at elevated temperature. After the mandrill is cured, the mold is removed, and the torque tube is wound on the mandrill, as described above. Since the mandrill is now a permanent part of the gear leg, the material should be flexible (have a low modulus of elasticity).

Thus there is no possibility that the fibers comprising the mandrill will break during an impact with the runway. With the mandrill being formed in this manner, it is a trivial task to incorporate substantial bands of impact fibers within the torque tube, as shown in FIG. 3 for example.

After the torque tube has cooled, the impact structure is formed. The top and bottom halves of the impact fibers are set into upper and lower molds. Before the epoxy begins to set, these molds are clamped around the finished torque tube and cured at elevated temperature. Then the external mold halves are removed.

Another approach to the fabrication of the impact structure is to use both internal and external molds for both halves of the impact structure and cure them separately. The two halves are then bonded together, with the torque tube bonded between them. This would be a more complicated process than attaching the two halves of the impact structure together before the epoxy begins to cure, but it would produce a better controlled thickness for the impact fiber structure.

Curing the part at elevated temperatures is essential. Epoxy (and other resins) will eventually cure at room temperature, but it takes years. Prior to being completely cured, the epoxy will flow if force is applied to it. Landing gear has force applied to it most of the time (whenever the plane is on the ground). The epoxy must be fully cured before the landing gear is installed in an airplane.

There are many other possible variations for the design and manufacture of composite gear legs employing separate materials for impact strength and torsional rigidity. All fall within the realm of the present disclosure.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A composite gear leg for an airplane, the gear leg comprising first and second fiber materials, the first fiber material having a high yield strength and low modulus of elasticity and primarily employed to store the energy of a hard landing, and the second fiber material formed of a different material than the first fiber material and having a modulus of elasticity higher than the first fiber material and a moderate to high yield strength and primarily employed to provide torsional stiffness in the gear leg, the first fiber material having fibers oriented substantially parallel to a longitudinal axis of the gear leg and the second fiber material having fibers oriented at an angle φ to the longitudinal axis of the gear leg, where φ is determined from the formula: cos² φ≦Yield(T)/Yield(I)*Elasticity(I)/Elasticity(T), where I represents the fibers running parallel to the longitudinal axis of the gear leg and T represents the fibers oriented at an angle to the longitudinal axis of the gear leg.

2. The composite gear leg of claim 1 employed to hold at least one main wheel of the airplane.

3. The composite gear leg of claim 1 employed to hold a nose wheel of the airplane.

4. The composite gear leg of claim 1 employed to hold a tail wheel of the airplane.

5. A leg for supporting an aircraft, comprising an elongate composite structure having a longitudinal axis, the composite structure containing fibers of a first material oriented in a first direction relative to the longitudinal axis of the leg and further containing fibers of a second material that is a different material from the first material and oriented in a second direction relative to the longitudinal axis of the leg.

6. The leg of claim 5, wherein the first fiber material has a lower modulus of elasticity than a modulus of elasticity of the second fiber material.

7. The leg of claim 6, wherein the first direction is parallel to the longitudinal axis of the leg and the second direction is at an angle to the longitudinal axis of the leg.

8. The leg of claim 7, wherein the angle is selected to avoid exceeding an elastic limit of the fibers of the second fiber material when the airplane is subjected to a hard landing.

9. An airplane, comprising:
at least one leg coupling a wheel to a structure on the airplane, the at least one leg comprising:
an elongate composite structure having a longitudinal axis, the structure comprising a first fiber material formed of a first substance having fibers oriented in a first direction relative to the longitudinal axis of the leg and further comprising a second fiber material formed of a second substance that is a different substance from the first substance and having fibers oriented in a second direction relative to the longitudinal axis of the leg.

10. The airplane of claim 9, wherein the first fiber material has a lower modulus of elasticity than a modulus of elasticity of the second fiber material.

11. The airplane of claim 10, wherein the first direction is parallel to the longitudinal axis of the leg and the second direction is an allowable angle φ to the longitudinal axis of the gear leg, where φ is determined from the formula: cos² φ≦Yield(T)/Yield(I)*Elasticity(I)/Elasticity(T), where I represents the fibers running parallel to the longitudinal axis of the gear leg and T represents the fibers oriented at an angle to the longitudinal axis of the gear leg.

12. The airplane of claim 11, wherein the angle is selected to avoid exceeding an elastic limit of the fibers of the second fiber material when the airplane is subjected to a hard landing.
